(19) United States
(12) Patent Application Publication
(10) Pub. No.: US 2016/0123067 A1
(43) Pub. Date: May 5, 2016

(54) CEMENT CASING FOR A DEVICE

(71) Applicant: DORMA Deutschland GmbH, Ennepetal (DE)

(72) Inventor: Hans-Rainer SPECKAMP, Ennepetal (DE)

(21) Appl. No.: 14/932,569

(22) Filed: Nov. 4, 2015

(30) Foreign Application Priority Data
Nov. 5, 2014 (DE) 102014116102.5

(51) Int. Cl. E06B 1/52; E05F 7/00; E06B 1/02

(52) U.S. Cl. CPC E06B 1/52; E06B 1/02; E05F 7/00

(57) ABSTRACT

A cement casing for the arrangement in a depression of a floor is made from at least partial metal material, including a base plate. From the direction of the base plate, the cement casing further includes walls extending at the respective border areas of the base plate essentially vertically to the base plate in the same direction. The walls are connected to the base plate. The walls opposite the connection to the base plate have a height plane, which essentially delimits the height of the cement casing. The cement casing further includes at least one element configured for the reception of a floor door closer, as well as a further element for the arrangement of a cover plate for covering the cement casing.

The cement casing includes at least one integral marking, which can be utilized for positioning the cement casing in a depression in a floor.

### FIELD

The present disclosure relates to a cement casing, which is to be placed into and affixed in a depression in a floor in order to be able to accommodate a device, for example a floor door closer. The cement casing can be aligned in the depression of the floor by means of markings, whereby the device when being positioned is already almost aligned in the cement box.

### BACKGROUND

The document DE 103 39 333 B4 discloses a floor door closer, which is enclosed by a cement casing, which is anchored in a recess embedded in the floor. The whole cement casing, including the floor door closer located therein, is covered on its top side by means of a cover plate, such that only this covering plate is visible from the outside. In this case, it is required that the floor door closer can be adjusted in the plane in the cement casing in all four directions, wherein the plane is the X-Y-plane. This procedure is disadvantageous in that in the absence of reference points, the installation of the cement casing is inaccurate. This may result in the fact that a cement casing inserted into the recess in the floor has a faulty positioning and therefore the floor door closer can not be adjusted sufficiently in the plane, in order to guarantee a reliable functioning of the floor door closer in conjunction with a corresponding door. The position of the cement casing in the X-Y-plane can just roughly be assessed.

Therefore, it is the object of the present disclosure to overcome the above-described disadvantages of the state-of-the-art. It is in particular the object of the present disclosure to increase the installation precision of the cement casing and thereby to keep the adjustment of the device in the cement casing to a minimum, so that the functioning of the device in conjunction with a corresponding door is given.

### SUMMARY

The inventive cement casing has at least one integral marking, which can be utilized for positioning the cement casing in a depression in a floor.

This solution offers the advantage for an installation technician to be able to align the cement casing by means of at least one integral marking in the depression of the floor such that the cement casing can be brought into a position, in which the device, for example a floor door closer, to be inserted into the cement casing is almost exactly aligned. In this case, the installation technician compares for example surrounding edges of the depression with the marking and positions the cement casing accordingly in the depression. Thus, the marking is used as a reference point for being able to position the cement casing. With the assistance of measuring instruments, for example a cross hair laser, nowadays used in the construction business, based on the markings in the X-Y-plane, the cement casing can be exactly aligned in the depression of the floor with regard to a top center of rotation, in which the door to be used later has its upper center of rotation. The lower center of rotation of the door to be used later is the axis of the floor door closer onto which the door is placed. Hereby, the cross hair laser can be positioned in that the latter is disposed in the area of the upper door bearing, wherein said positioning of the cross hair laser coincides with the top center of rotation of the door to be actuated. The cross hair laser radiates perpendicularly into the depression in the floor and represents the point at the location at which the axis of rotation of the floor door closer will be disposed in a later mounting step. The cross hair laser may be used for example in such a way that the installation technician moves the cement casing within the depression until the correspondingly set laser beams coincide with the one marking or several markings, and are therefore congruent, whereby the cement casing is positioned. In the correct oriented position the cement casing is now attached to the structural body. The attached cement casing thus forms a thrust bearing for the reception of the door weight forces and of those of the door closer mechanism. By positioning the cement casing in the depression of the floor, an adjustment of the floor door closer by the installation technician in the cement casing in all four directions of the X-Y-plane is not necessarily required any more. However, in case nevertheless an adjustment of the floor door closer should become necessary in the cement casing, said adjustment will be very minor and range in the millimeters. With the assistance of at least one marking in conjunction with a cross hair laser, the positioning of the cement casing in the depression of the floor in the X-Y-plane can be realized in a respective range between 0.5 mm to 10 mm, preferred between 0.5 mm and 5 mm, in particular preferred between 0.5 mm and 2 mm.

It is advantageous, if at least one marking can be located in the area of the height plane, wherein the height plane represents the height of the cement casing. When inserting the cement casing into the depression of the floor, the installation technician mostly perceives the markings in the area of the height plane, which allows him to align the markings in relation to reference points, which may be located in the direct vicinity of the depression of the floor, such as for example parallel extending edges of the depression, or with additional technical assistance, such as when using a cross hair laser or the laser beams thereof. Said markings may be disposed in a plane plane-parallel to the base plate.

It is furthermore advantageous, if the walls have a wall thickness penetrated by the marking and/or if the marking can at least partially reach into the wall. Such markings may be introduced into the respective wall thickness in a simple way when manufacturing the cement casing, and, when comparing to reference points, they offer the installation technician a simple option for realizing the alignment of the cement casing in the depression of the floor. The wall thickness of the cement casing may be determined depending on the material to be utilized for the stability of the cement casing, so as to guarantee the form stability of the cement casing.

It is also advantageous, if at least one marking extends from the height plane in the direction of the base plate in the height plane in such a way that the marking interrupts the height plane. Thus, when employing a laser when aligning the cement casing in the depression of the floor, the cement casing can be adjusted in the depression until a laser beam from the top, as described above, reaches the corresponding marking, whereby the cement casing is aligned within the depression of the floor.

Advantageously, at least one pair of markings may be arranged in pairs opposite each other in the area of the height plane essentially perpendicularly, preferably at an angle of 90° to a center axis of the cement casing. When utilizing markings opposite each other in pairs on the height plane, two laser beams of the cross hair laser may be used, in order to be able to perform the alignment of the cement casing in the depression of the floor, whereby the cement casing is aligned, as soon as the two markings are congruent with the respective associated laser beams. By using a corresponding cross hair laser for aligning the cement casing in the depression of the floor, the installation technician has the possibility of adjusting the cement casing in all four directions in the X-Y-plane. It is likewise conceivable to use more than two markings for performing the alignment of the cement casing in the depression of the floor.

Also advantageously, a pair of markings may be disposed centrally or off-center to the longitudinal extension of the cement casing in the area of the height plane, which can be utilized for the positioning of the cement casing in the depression of the floor. Depending for example on the setting of the laser beam device and thus the laser beams thereof, the cement casing may be likewise aligned with said markings in a very simple way in the depression of the floor.

Furthermore, it may be advantageous, if the pairs of markings opposite each other are located in the longitudinal extension of the cement casing, wherein the pairs of markings opposite each other are disposed between the walls of the longitudinal extension of the cement casing in the area of the height plane, which can be utilized for positioning the cement casing in the depression of the floor. Depending for example on the setting of the laser beam device and thus on the laser beams thereof, the cement casing may be likewise aligned with said markings in a very simple way in the depression of the floor.

Advantageously, parallel spacings may be provided between the wall, located in the longitudinal extension, and a first plane as well as a second plane of the markings, which spacings form a first position measure (A) and a second position measure (B). As so-called pivot center dimension, which depends on the employed door fittings, is in particular important for the kinematics of a floor door closer. This first position measure A thus represents a first pivot center dimension, wherein the second position measure B represents a second pivot center dimension, wherein the first pivot center dimension and the second pivot center dimension have different dimensions. The alignment of the cement casing in the depression of the floor by utilizing said markings ensures that the pivot center dimensions, which are important the floor door closer, can be respected.

The first position measure A may range between 46 mm and 56 mm, preferred between 49 mm and 53 mm, and particularly preferred between 50 mm and 52 mm, wherein the second position measure B may range between 60 mm and 70 mm, preferred between 63 mm and 67 mm, particularly preferred between 64 mm and 66 mm. When using said spacings from the frontal-side wall to the markings of the corresponding positions and with the appropriate alignment of the cement casing using the respective markings, the kinematics of the floor door closer to be employed are guaranteed.

Advantageously, the form of the marking may be configured V-shaped and/or square and/or rectangular and/or half-round and/or circularly arched and/or slot-shaped. When manufacturing the cement casing, said forms of the markings are easy to realize in or at the wall of the cement casing.

Advantageously, the at least one marking may be advantageously stamped and/or molded and/or notched and/or compressed and/or imprinted and/or glued. In this case, there are options for affixing markings to the cement casing, which can be individually realized.

Furthermore, it may be advantageous, if one marking is disposed at or in the base plate. The base plate of the cement casing offers a larger surface for affixing markings, whereby for example the center of rotation of the axis of the floor door closer can be employed as the point for aligning the cement casing in the depression of the floor. Said point is the point of reference for a perpendicular alignment of the door to be employed, wherein dropping the perpendicular may be realized as well with traditional means and/or with a laser.

It may be also an advantage, if the marking is stamped and/or molded and/or notched and/or compressed and/or imprinted and/or glued to or in the base plate. In this case, there are options for affixing markings to the base plate of the cement casing, which can be individually realized.

Another advantage may be, if another marking is associated to the marking at or in the base plate, which markings are disposed opposite each other at or in the base plate.

When utilizing markings opposite each other in pairs at or in the base plate, two laser beams of the laser beam device may be used, which device has been appropriately aligned prior to positioning the cement casing, in order to perform the positioning of the cement casing in the depression of the floor, whereby the cement casing is aligned, as soon as the two markings are congruent with the respective associated laser beams. It is likewise conceivable to use more than two markings and a corresponding number of laser beams for performing the positioning of the cement casing in the depression of the floor.

The markings, in particular those, which are disposed at or in the base plate, may still serve as position reference for other devices, such as for example a door opening delimiter or a closing sequence controller.

Advantageously, said markings may be disposed in a plane plane-parallel to the base plate.

### BRIEF DESCRIPTION OF THE DRAWINGS

In the drawings:

FIG. 1 shows the cement casing in a perspective view,

FIG. 2 shows a detailed view of FIG. 1,

FIG. 3 shows the cement casing in a lateral view.

### DETAILED DESCRIPTION OF THE DRAWINGS

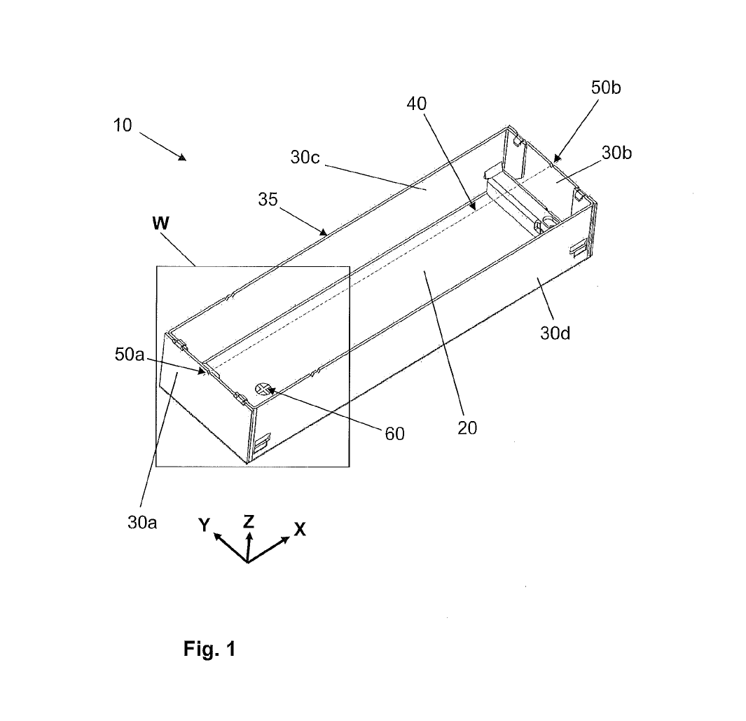

The cement casing 10 is illustrated in FIG. 1 in a perspective view. The cement casing has a base plate 20, which in FIG. 1 is located in the X-Y-plane and includes a marking 60. Preferably, said base plate has a rectangular shape. Walls 30a, 30b, 30c, and 30d are disposed at the base plate, which, in the area of the border regions of the base plate 20, are connected to the base plate 20, and extend from the base plate 20 essentially vertical in the same direction. In FIG. 1, the direction of extension of the walls 30a, 30b, 30c, and 30d is the direction of the arrow Z. Said walls 30a, 30b, 30c, and 30d are configured, seen from the base plate 20, such as to present essentially the same height, whereby the cement casing has a height plane 35, which delimits the height of the cement casing 10 from the base plate 20. The walls 30a and 30b are disposed to be opposite each other at the base plate 20, wherein said walls 30a and 30b are preferably disposed parallel to each other at the base plate 20. The walls 30c and 30d are disposed to be opposite each other at the base plate 20, wherein said walls 30b and 30d are preferably disposed parallel to each other at the base plate 20. In longitudinal extension of the cement casing 10, which runs in the direction X of the X-Y-plane, the cement casing 10 has a central axis 40, which in FIG. 1 is illustrated at the height of the height plane 35. The longitudinal extension of the cement casing 10 is delimited by the walls 30a and 30b, wherein, in the area of the height plane 35 and of the central axis 40, the wall 30a has a marking 50a and, in the area of the height plane 35 and of the central axis 40, the wall 30b has a marking 50b. Furthermore, FIG. 1 presents a detail indication W.

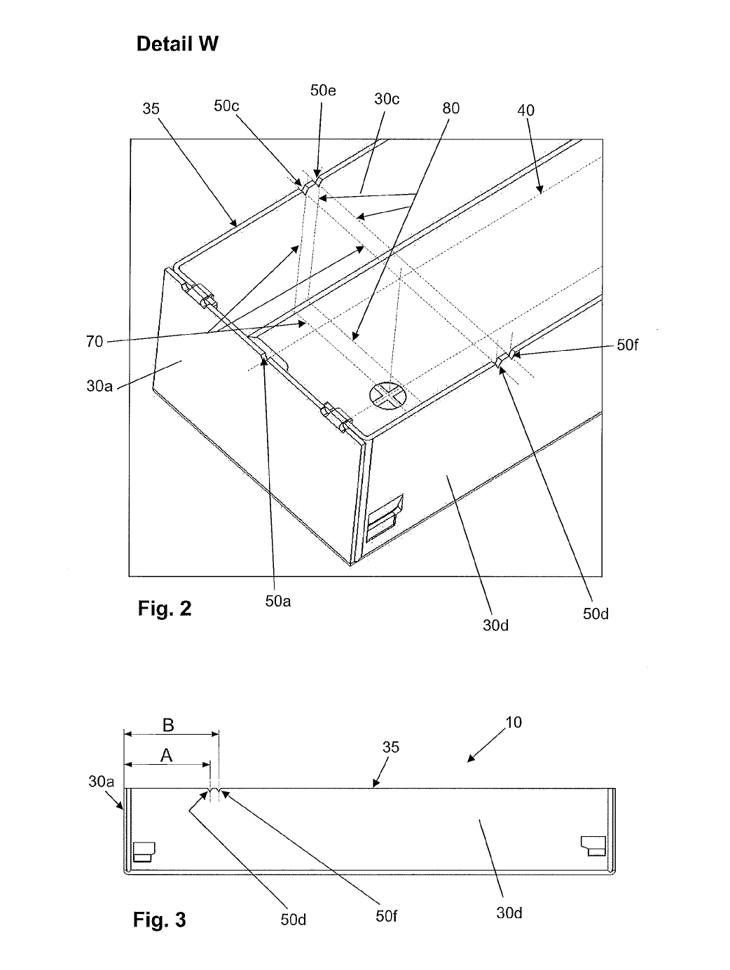

FIG. 2 shows the detailed view W of FIG. 1. In the area of the height plane 35, the wall 30a has the marking 50a, wherein, in the area of the height plane 35, the wall 30c has the markings 50c and 50e. In the area of the height plane 35, the wall 30d has the markings 50d and 50f. The markings 50c and 50d are disposed to be opposite each other on a first plane 70, wherein they form a pair of markings and the first plane 70 extends parallel to the wall 30a. The markings 50e and 50f are disposed to be opposite each other on a second plane 80, wherein they form a pair of markings and the second plane 80 extends parallel to the wall 30a.

FIG. 3 shows the cement casing 10 in a lateral view. The markings 50d and 50f are disposed in the area of the height plane 35 of the wall 30d. The position of the first marking A is parallel spaced apart from the wall 30a, and the position of the second marking B is parallel spaced apart from the wall 30a, wherein the two positions A and B present different spacings to the wall 30a. The two positions of the markings A and B serve for being able to position the cement casing in the depression of the floor in such a way that, depending on the required pivot center dimension, said dimension can be respected and the cement casing can be accordingly disposed in the depression.

The cement casing 10, which essentially comprises metal material, has at least one marking 50a, 50b, 50c, 50d, 50e, 50f, and 60, which can be used for positioning the cement casing 10 in the depression of the floor. Said markings 50a, 50b, 50c, 50d, 50e, 50f, and 60 are affixed in or to the cement casing 10 in a conventional manner by stamping and/or embossing and/or notching and/or compressing and/or imprinting and/or gluing. Advantageously, the marking 50a, 50b, 50c, 50d, 50e, 50f is disposed in an area, which is well visible for the installation technician, who positions the cement casing in the depression of the floor. Said area is preferably the height plane 35, which delimits the height of the cement casing 10 from the base plate 20. Several markings 50a, 50b, 50c, 50d, 50e, 50f can be disposed in the area of the height plane 35, wherein the markings 50a and 50b and/or 50c and 50d and/or 50e and 50f may be disposed opposite each other as a respective pair of markings. Furthermore, the base plate 20 may include a marking 60, wherein another marking may be associated to said marking 60, whereby at least one pair of markings is disposed at the base plate 20.

The installation technician compares the markings 50a, 50b, 50c, 50d, 50e, 50f, and 60 to points of reference, which comprise for example surrounding edges of the depression of the floor, or can be generated by means of auxiliary tools, for example a laser beam device or a cross hair laser. The laser beam device or the cross hair laser are disposed in an area of the upper door frame, in which a door is to be installed, which a floor door closer moves into the closed position, wherein the floor door closer is disposed in the cement casing 10. The laser beam device or the cross hair laser is aligned at the door frame, such that at the location, where the axis of rotation of the floor door closer is to be disposed, a laser beam radiates perpendicularly into the depression of the floor. Thus a point of reference is produced for allowing to position the cement casing 10 in the depression of the floor.

The cross hair laser is disposed in the same way at the structural body, such that the laser and thus the laser markings thereof are in alignment direction of the planned door installation, wherein the laser beams, which can be utilized for positioning the cement casing 10, are adjusted to the cement casing to be employed, so that the comparison with the markings 50a, 50b, 50c, 50d, 50e, 50f can be performed. The cross hair laser may be adjusted and used for example in such a way that the installation technician moves the cement casing 10 within the depression of the floor in the X-Y-plane so long until the correspondingly set laser beams coincide with the one marking 50a, 50b, 50c, 50d, 50e, 50f, and 60 or several markings 50a, 50b, 50c, 50d, 50e, 50f, and 60, and are therefore congruent, whereby the cement casing 10 is positioned.

The cement casing 10 has markings 50c and 50d, which are parallel spaced apart from the frontal-side wall 30a and are disposed in pairs opposite each other at the cement casing 10. Said parallel spacing forms a first position measure A. Furthermore, the cement casing 10 has markings 50e and 50f, which are parallel spaced apart from the frontal-side wall 30a and are disposed in pairs opposite each other at the cement casing 10. Said parallel spacing forms a second position measure B. Said two position measures A and B represent different pivot center dimensions, which are important for the kinematics of the floor door closer, wherein, by means of the markings 50c and 50d, as well as 50e and 50f, the cement casing 10 can be positioned in relation to the corresponding pivot center dimensions.

1. A cement casing for arrangement in a depression in a floor and being made from an at least partially metal material, including
a base plate, and
from the direction of the base plate, walls extending at the border areas of the base plate essentially vertically to the base plate, wherein
the walls are connected to the base plate, and
the walls, opposite the connection to the base plate, have a height plane, which essentially delimits the height of the cement casing,
at least one element, which is configured for the reception of a floor door closer, as well as at least one further element for the arrangement of a cover plate for covering the cement casing,
wherein
the cement casing includes at least one integral marking, which can be utilized for the positioning of the cement casing in the depression of the floor.

2. The cement casing according to claim 1, wherein at least one marking is disposed in the area of the height plane.

3. The cement casing according to claim 1, wherein the walls have a wall thickness, through which the marking passes and/or into which the marking reaches at least partially.

4. The cement casing according to claim 1, wherein, from the height plane in the direction of the base plate, at least one marking extends in the height plane such that marking interrupts the height plane.

5. The cement casing according to claim 1, wherein at least one pair of markings and and/or and and/or and is/are disposed opposite each other in the area of the height plane essentially transversely, at an angle of 90° to a central axis of the cement casing.

6. The cement casing according to claim 1, wherein the markings and as well as and, which are opposite each other, are disposed between the walls and in the area of the height plane.

7. The cement casing according to claim 1, wherein the marking and are disposed centrally or off-center of the longitudinal extension of the cement casing in the area of the height plane.

8. The cement casing according to claim 1, wherein a parallel spacing is provided between the wall and the first plane of the markings, which spacing forms a pivot center dimension, wherein a parallel spacing is provided between the wall and the second plane of the markings, which spacing forms a pivot center dimension.

9. The cement casing according to claim 1, wherein the first position measure ranges between 46 mm and 56 mm, wherein the second position measure of the second marking ranges between 60 mm and 70 mm.

10. The cement casing according to claim 1, wherein the shape of the marking is configured to be V-shaped and/or square and/or rectangular and/or half-round and/or circularly arched and/or slot-shaped.

11. The cement casing according to claim 1, wherein at least one marking is stamped and/or embossed and/or notched and/or compressed and/or imprinted and/or glued.

12. The cement casing according to claim 1, wherein the marking is disposed at or in the base plate.

13. The cement casing according claim 12, wherein the marking is stamped and/or embossed and/or notched and/or compressed and/or imprinted and/or glued.

14. The cement casing according to claim 12, wherein a further marking is associated to the marking, which together with the marking are disposed in pairs opposite each other at or in the base plate.

15. The cement casing according to claim 1, wherein the first position measure ranges between 49 mm and 53 mm, wherein the second position measure of the second marking ranges between 63 mm and 67 mm.

16. The cement casing according to claim 1, wherein the first position measure ranges between 50 mm and 52 mm, wherein the second position measure of the second marking ranges between 64 mm and 66 mm.
